(19) United States
(12) Patent Application Publication
(10) Pub. No.: US 2025/0092986 A1
(43) Pub. Date: Mar. 20, 2025

(54) SPATIAL LOCATION PRECISION STABILIZATION SYSTEM WITH DUAL LEVEL MULTI-DEGREE OF FREEDOM

(71) Applicant: ZJU-HANGZHOU GLOBAL SCIENTIFIC AND TECHNOLOGICAL INNOVATION CENTER, Hangzhou (CN)

(72) Inventor: Ning LI, Hangzhou (CN)

(21) Appl. No.: 18/017,444

(22) PCT Filed: Nov. 16, 2022
(86) PCT No.: PCT/CN2022/132274

§ 371 Date: Jan. 23, 2023

(30) Foreign Application Priority Data
Dec. 10, 2021 (CN) 202111510470.9

(51) Int. Cl. F16M 11/18

(52) U.S. Cl. CPC F16M 11/18

(57) ABSTRACT

A spatial location precision stabilization system with dual level multi-degree of freedom is provided. The system includes a motion platform; a second-level platform connected to the motion platform and located below the motion platform, the second-level platform is provided with a second electromagnetic driving component to adjust a position of the motion platform; a first-level platform connected to the second-level platform and located below the second-level platform, the first-level platform is provided with a first electromagnetic driving component to adjust the second-level platform, so as to adjust the position of the motion platform; and a controller configured to control the first electromagnetic driving component and the second electromagnetic driving component.

### CROSS-REFERENCE TO RELATED APPLICATIONS

This application claims priority to Chinese patent application No. 202111510470.9, filed on Dec. 10, 2021, titled “SPATIAL LOCATION PRECISION STABILIZATION SYSTEM WITH DUAL LEVEL MULTI-DEGREE OF FREEDOM”. The content of the above identified application is hereby incorporated herein in its entirety by reference.

### TECHNICAL FIELDS

The present disclosure relates to a field of precision stabilization of spatial location, and in particular, to a spatial location precision stabilization system with dual level multi-degree of freedom.

### BACKGROUND

At present, with the development of advanced manufacturing technology, high-end devices oriented to nano-scale positioning control and nano-scale operation on materials or devices have received increasing attention, and based on demand upgrading and rapid technology iteration in a field of linear drive, transmission precision and response speed of conventional actuators such as a ball screw can no longer meet the current demand for precision linear drive due to its long transmission chain and great cumulative system error.

At the same time, it is inevitable that the influence of mechanical vibrations on imaging quality, measurement accuracy and accuracy for target tracking and aiming of an optical system. At present, mainstream vibration isolation methods can be divided into active vibration isolation and passive vibration isolation. However, the active vibration isolation and the passive vibration isolation are both vibration isolation between devices and foundation, and difference between the two is that a form of vibration source is different. Therefore, for the optical devices (lasers, etc.) at an end of a vibration isolation chain, vibration or disturbance isolation in a spatial range cannot be well achieved, so that a spatial location precision stabilization system is required to stabilize the optical devices.

### SUMMARY

According to various embodiments of the present disclosure, a spatial location precision stabilization system with dual level multi-degree of freedom is provided.

The present disclosure provides a spatial location precision stabilization system with dual level multi-degree of freedom, and the system includes a motion platform, a second-level platform, a first-level platform and a controller. The second-level platform is connected to the motion platform and located below the motion platform, and the second-level platform is provided with a second electromagnetic driving component to adjust a position of the motion platform in multiple directions by means of electromagnetic actuation. The first-level platform is connected to the second-level platform and located below the second-level platform, and the first-level platform is provided with a first electromagnetic driving component to adjust the second-level platform in multiple directions by means of electromagnetic actuation, so as to adjust the position of the motion platform. The controller is connected to the first electromagnetic driving component and the second electromagnetic driving component, and configured to control the first electromagnetic driving component and the second electromagnetic driving component.

In some embodiments, the second-level platform is configured to adjust the position of the motion platform along three directions of X-axis, Y-axis and Z-axis under driven by the second electromagnetic driving component. The first-level platform is configured to adjust the second-level platform along three directions of X-axis, Y-axis and Z-axis under driven by the first electromagnetic driving component, so as to adjust the position of the motion platform.

In some embodiments, the first electromagnetic driving component includes an electromagnetic actuating unit I, an electromagnetic actuating unit II, and an electromagnetic actuating unit III.

The first-level platform includes a first-level bottom plate, a first-level Z-axis motion unit, a first-level Y-axis motion unit and a first-level X-axis motion unit. The first-level Z-axis motion unit is movably connected to the first-level bottom plate along a Z-axis direction, and an electromagnetic actuation unit I is disposed between the first-level Z-axis motion unit and the first-level bottom plate and configured for driving the first-level Z-axis motion unit to move along the Z-axis direction. The first-level Y-axis motion unit is movably connected to the first-level Z-axis motion unit along a Y-axis direction, and an electromagnetic actuation unit II is disposed between the first-level Y-axis motion unit and the first-level Z-axis motion unit and configured for driving the first-level Y-axis motion unit to move along the Y-axis direction. The first-level X-axis motion unit is movably connected to the first-level Y-axis motion unit along a X-axis direction, and the first-level Y-axis motion unit is provided with a guide groove, a bottom of the second-level platform is provided with a guide protrusion matching with the guide groove, and an electromagnetic actuation unit III is disposed between the guide protrusion and the guide groove and configured for driving the second-level platform to move along the X-axis direction.

In some embodiments, the first-level bottom plate is provided with an U-shaped groove I, the first-level Z-axis motion unit is provided with a guide strip I cooperating with the U-shaped groove I, and the electromagnetic actuation unit I is located between the U-shaped groove I and the guide strip I. The first-level Z-Axis motion unit is provided with an U-shaped groove II, the first-level Y-axis motion unit is provided with a guide strip II cooperating with the U-shaped groove II, and the electromagnetic actuation unit II is located between the U-shaped groove II and the guide strip II.

In some embodiments, the second electromagnetic driving component includes an electromagnetic actuation unit IV, an electromagnetic actuation unit V, and an electromagnetic actuation unit VI. The second-level platform includes a second-level bottom plate, a second-level Y-axis motion unit, and a second-level X-axis motion unit. The guide protrusion is located on a bottom of the second-level bottom plate, and the electromagnetic actuation unit IV is configured for driving the second-level bottom plate to move along the Z-axis direction and located between the guide protrusion and the guide groove. The second-level Y-axis motion unit is movably connected to the second-level bottom plate along the Y-axis direction, and the electromagnetic actuation unit V is configured for driving the second-level Y-axis motion unit to move along the Y-axis direction and located between the second-level Y-axis motion unit and the second-level bottom plate. The second-level X-axis motion unit is movably connected to the second-level Y-axis motion unit along the X-axis direction, the electromagnetic actuation unit VI is configured for driving the second-level X-axis motion unit to move along the X-axis direction and located between the second-level X-axis motion unit and the second-level Y-axis motion unit, and the motion platform is connected to the second-level X-axis motion unit.

In some embodiments, the second-level bottom plate is provided with an U-shaped groove III, the second-level Y-axis motion unit is provided with a guide strip III cooperating with the U-shaped groove III, and the electromagnetic actuation unit V is located between the U-shaped groove III and the guide strip III. The second-level Y-axis motion unit is provided with an U-shaped groove IV, the second-level X-axis motion unit matches with the U-shaped groove IV, and the electromagnetic actuation unit VI is located between the U-shaped groove IV and the second-level X-axis motion unit.

In some embodiments, a grating ruler sensor I configured for detecting a relative position between the first-level bottom plate and the first-level Z-axis motion unit is provided between the U-shaped groove I and the guide strip I. A grating sensor II configured for detecting a relative position between the first-level Z-axis motion unit and the first-level Y-axis motion unit is provided between the U-shaped groove II and the guide strip II. A grating sensor III configured for detecting a relative position between the first-level Y-axis motion unit and the second-level bottom plate along the X-axis direction and a grating ruler sensor IV configure for detecting a relative position of the first-level Y-axis motion unit and the second-level bottom plate along the Z-axis direction are provided in the guide protrusion and the guide groove. A grating ruler sensor V configured for detecting a positional relationship between the second-level bottom plate and the second-level Y-axis motion units is provided between the U-shaped Groove III and the guide strip III. A grating ruler sensor VI configured for detecting a positional relationship between the second-level Y-axis motion unit and the second-level X-axis motion unit is provided between the U-shaped groove IV and the second-level X-axis motion unit.

In some embodiments, the spatial location precision stabilization system with dual level multi-degree of freedom further includes a detection unit configured to detect a position variation of the motion platform.

When the position variation of the motion platform detected by the detection unit reaches a preset value, the controller is capable of controlling the first electromagnetic driving component to adjust the motion platform. When the position variation of the motion platform detected by the detection unit does not reach the preset value, the controller is capable of controlling the second electromagnetic driving component to adjust the motion platform.

In some embodiments, the spatial location precision stabilization system with dual level multi-degree of freedom further includes a detection unit configured to detect a position variation of the motion platform in three directions of X-axis, Y-axis and Z-axis,
for a position variation in the X-axis direction, when the detection unit detects that the position variation in the X-axis direction reaches a preset value, the controller is capable of controlling the electromagnetic actuation unit III of the first electromagnetic driving component to adjust the motion platform, and when the detection unit detects that the position variation in the X-axis direction does not reach the preset value, the controller is capable of controlling the electromagnetic actuation unit VI of the second electromagnetic driving component to adjust the motion platform;
for a position variation in the Y-axis direction, when the detection unit detects that the position variation in the Y-axis direction reaches a preset value, the controller is capable of controlling the electromagnetic actuation unit II of the first electromagnetic driving component to adjust the motion platform, and when the detection unit detects that the position variation in the Y-axis direction does not reach the preset value, the controller is capable of controlling the electromagnetic actuation unit V of the second electromagnetic driving component to adjust the motion platform; and
for a position variation in the Z-axis direction, when the detection unit detects that the position variation in the Z-axis direction reaches a preset value, the controller is capable of the electromagnetic actuation unit I of the first electromagnetic driving component to adjust the motion platform, and when the detection unit detects that the position variation in the Z-axis direction does not reach the preset value, the controller is capable of the electromagnetic actuation unit IV of the second electromagnetic driving component to adjust the motion platform.

In some embodiments, the preset value is in a range from 0.1 mm to 2 mm.

Advantages of the present application is as following. In the spatial location precision stabilization system with dual level multi-degree of freedom, an electromagnetic direct drive technology can be used to simplify intermediate drive mechanical structures, so as to realize a linear positioning function with high precision and rapid response.

Furthermore, in the spatial location precision stabilization system with dual level multi-degree of freedom, spatial position adjustment of dual level three-degree of freedom can be realized, so that vibration/disturbance of three degrees of freedom in a space range can be offset, improving optical test precision.

The details of one or more embodiments of the present disclosure are set forth in the accompanying drawings and the description below. Other features, objects and advantages of the present disclosure will become apparent from the description, drawings and claims.

### BRIEF DESCRIPTION OF THE DRAWINGS

In order to better describe and explain the embodiments and/or examples of those inventions disclosed herein, one or more drawings may be referred to. The additional details or examples used to describe the drawings should not be considered as limiting the scope of any of the disclosed inventions, the currently described embodiments and/or examples, and the best mode of these inventions currently understood.

FIG. 1 is a schematic view of a spatial location precision stabilization system with dual level multi-degree of freedom in one or more embodiments of the present disclosure.

FIG. 2 is a schematic view of a second-level platform of a spatial location precision stabilization system with dual level multi-degree of freedom in one or more embodiments of the present disclosure.

FIG. 3 is a schematic view of a second-level platform of a spatial location precision stabilization system with dual level multi-degree of freedom in another view angle in one or more embodiments of the present disclosure.

FIG. 4 is a schematic view of a first-level platform of a spatial location precision stabilization system with dual level multi-degree of freedom in one or more embodiments of the present disclosure.

FIG. 5 is a schematic view of a spatial location precision stabilization system with dual level multi-degree of freedom in one or more embodiments of the present disclosure.

FIG. 6 is a schematic view of a spatial location precision stabilization system with dual level multi-degree of freedom in one or more embodiments of the present disclosure.

FIG. 7 is a schematic view of a first-level platform of a spatial location precision stabilization system with dual level multi-degree of freedom in one or more embodiments of the present disclosure.

FIG. 8 is a schematic view of a second-level platform of a spatial location precision stabilization system with dual level multi-degree of freedom in one or more embodiments of the present disclosure.

In the figures, 100 represents a spatial location precision stabilization system with dual level multi-degree of freedom, 1 represents a motion platform, 2 represents a second-level platform, 21 represents a second-level X-axis motion unit, 22 represents a Y-axis linear guide rail slider assembly II, 23 represents a second-level bottom plate, 231 represents a guide protrusion, 232 represents an U-shaped groove III, 24 represents a X-axis linear guide rail slider assembly II, 25 represents a second-level Y-axis motion unit, 251 represents a guide strip III, 252 represents an U-shaped groove IV, 26 represents a second electromagnetic driving component, 261 represents an electromagnetic actuation unit IV, 262 represents an electromagnetic actuation unit V, 263 represents an electromagnetic actuation unit VI, 3 represents a first-level platform, 31 represents a first-level Z-axis motion unit, 311 represents a guide strip I, 312 represents U-shaped groove II, 32 represents a first-level bottom plate, 321 represents an U-shaped groove I, 33 represents an X-axis linear guide rail slider assembly I, 34 represents a first-level Y-axis motion unit, 341 represents a guide strip II, 342 represents a guide groove, 35 represents a first-level X-axis motion unit, 36 represents a Y-axis linear guide rail slider assembly I, 37 represents a first electromagnetic driving component, 371 represents an electromagnetic actuation unit I, 372 represents an electromagnetic actuation unit II, 373 represents an electromagnetic actuation unit III, 4 represents a controller, 5 represents a detection unit, 61 represents a grating ruler sensor I, 62 represents a grating ruler sensor II, 63 represents a grating ruler sensor III, 64 represents a grating ruler sensor IV, 65 represents a grating ruler sensor V, and 66 represents a grating ruler sensor VI.

### DETAILED DESCRIPTION

The present application is described in detail below with reference to the accompanying drawings and specific embodiments.

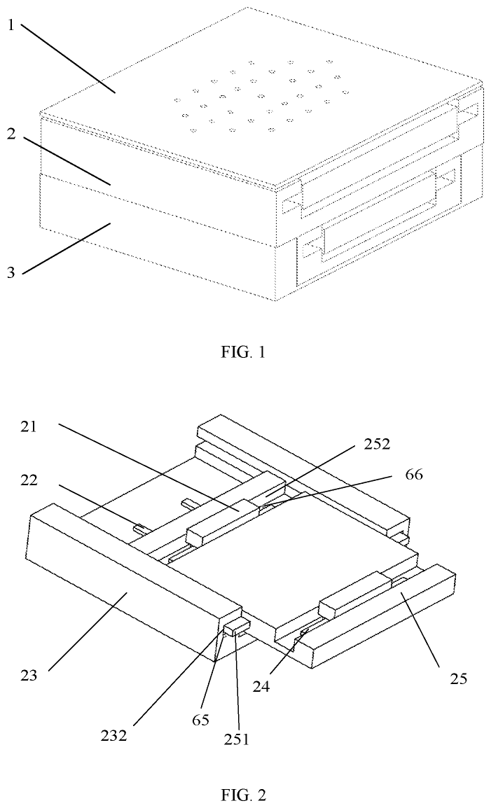

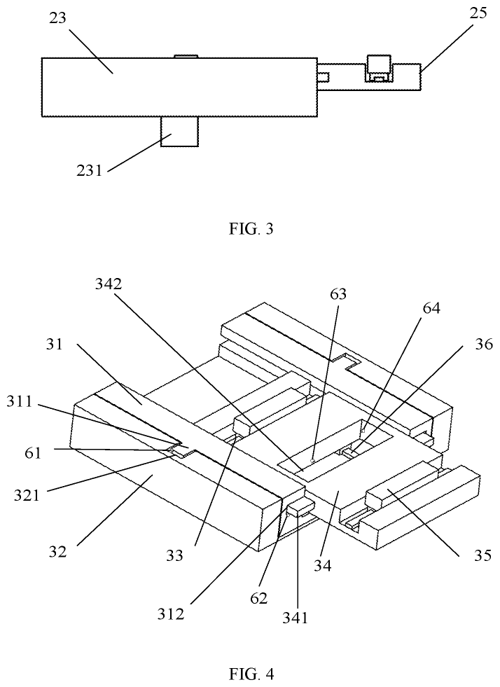

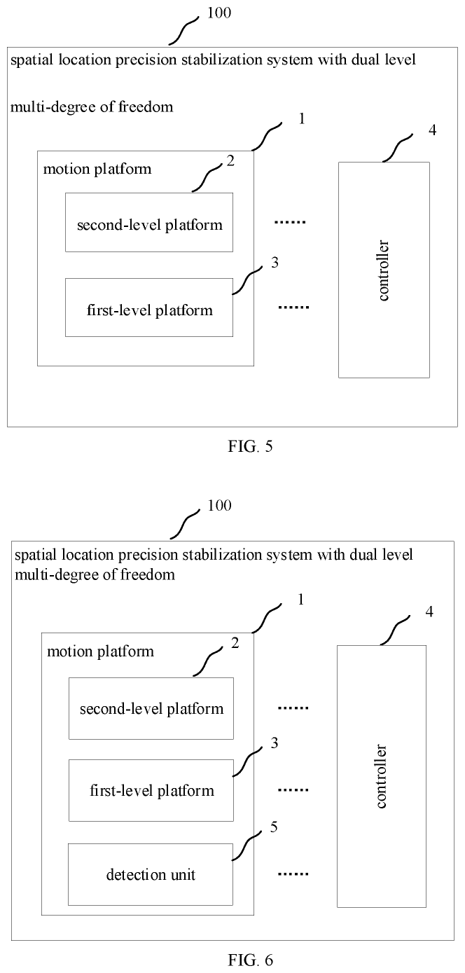

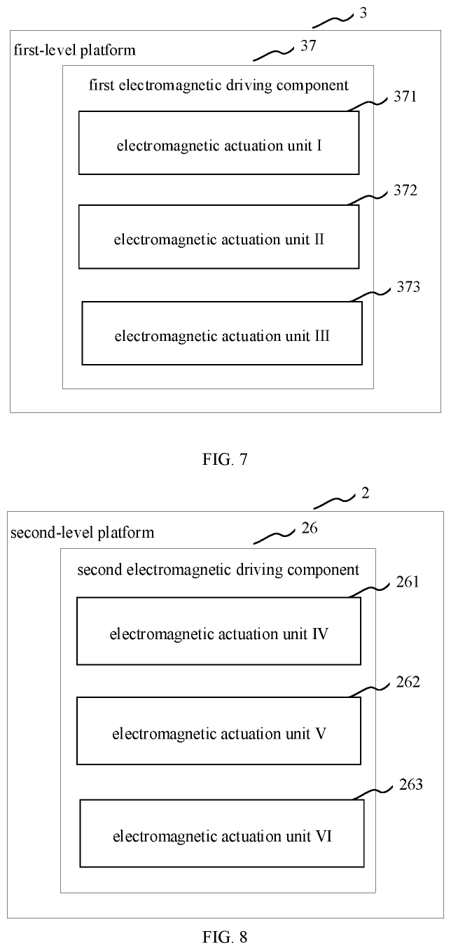

FIG. 1 to FIG. 8 are schematic views of a spatial location precision stabilization system 100 with dual level multi-degree of freedom in the present disclosure. The spatial location precision stabilization system can include a motion platform 1, a second-level platform 2, a first-level platform 3 and a controller 4. The second-level platform 2 is connected to the motion platform 1 and located below the motion platform 1, and the second-level platform 2 is provided with a second electromagnetic driving component to adjust a position of the motion platform 1 in multiple directions by means of electromagnetic actuation. The first-level platform 3 is connected to the second-level platform 2 and located below the second-level platform 2, and the first-level platform 3 is provided with a first electromagnetic driving component 37 to adjust the second-level platform 2 in multiple directions by means of electromagnetic actuation. Since the motion platform 1 is directly connected to the second-level platform 2, the second-level platform 2 can be adjusted to adjust the position of the motion platform 1. The controller 4 is connected to the first electromagnetic driving component 37 and the second electromagnetic driving component 26 and configured to control the first electromagnetic driving component 37 and the second electromagnetic driving component 26, so as to drive the first-level platform 3 and the second-level platform 2, respectively.

In the present embodiment, the second-level platform 2 can be configured to adjust the position of the motion platform 1 along three directions of X-axis, Y-axis and Z-axis under driven by the second electromagnetic driving component 26, and the first-level platform 3 can be configured to adjust the second-level platform 2 along three directions of X-axis, Y-axis and Z-axis under driven by the first electromagnetic driving component 37, so as to adjust the position of the motion platform 1. The above-mentioned components and parts can be described below.

Specifically, the first electromagnetic driving component 37 can include an electromagnetic actuation unit I 371, an electromagnetic actuation unit II 372, and an electromagnetic actuation unit III 373. The first-level platform 3 can include a first-level bottom plate 32, a first-level Z-axis motion unit 31, a first-level Y-axis motion unit 34 and a first-level X-axis motion unit 35. The first-level bottom plate 32 is required to be mounted in a position without obstructions around and as far away from vibration sources as possible, so as to ensure good stability and precision. The first-level Z-axis motion unit 31 can be movably connected to the first-level bottom plate 32 along a Z-axis direction. The electromagnetic actuation unit I 371 can be disposed between the first-level Z-axis motion unit 31 and the first-level bottom plate 32 and configured for driving the first-level Z-axis motion unit 31 to move along the Z-axis direction. The first-level Y-axis motion unit 34 can be movably connected to the first-level Z-axis motion unit 31 along a Y-axis direction, and the electromagnetic actuation unit II 372 can be disposed between the first-level Y-axis motion unit 34 and the first-level Z-axis motion unit 31 and configured for driving the first-level Y-axis motion unit 34 to move along the Y-axis direction. The first-level X-axis motion unit 35 can be movably connected to the first-level Y-axis motion unit 34 along a X-axis direction, and the first-level Y-axis motion unit 34 can be provided with a guide groove 342, a bottom of the second-level platform 2 can be provided with a guide protrusion 231 matching with the guide groove 342, and the electromagnetic actuation unit III 373 can be disposed between the guide protrusion 231 and the guide groove 342 and configured for driving the second-level platform 2 to move along the X-axis direction.

In the present disclosure, the first-level bottom plate 32 can be provided with an U-shaped groove I 321, the first-level Z-axis motion unit 31 can be provided with a guide strip I 311 cooperating with the U-shaped groove I 321, and the electromagnetic actuation unit I 371 can be located between the U-shaped groove I 321 and the guide strip I 311. The electromagnetic actuation unit I 371 can include a coil and a permanent magnet, the coil can be mounted on the guide strip I 311, and the permanent magnet can be mounted on the U-shaped groove I 321. When the coil is energized, the guide strip I 311 can be driven by electromagnetic force and move along the U-shaped groove I 321. The structure and principle of electromagnetic actuation unit described below can be the same and will not be repeated herein. The first-level Z-Axis motion unit 31 can be provided with an U-shaped groove II 312, the first-level Y-axis motion unit 34 can be provided with a guide strip II 341 cooperating with the U-shaped groove II 312, and the electromagnetic actuation unit II 372 can be located between the U-shaped groove II 312 and the guide strip II 341.

In the present disclosure, the first-level platform 3 can further include a X-axis linear guide rail slide assembly I 33 and a Y-axis linear guide rail slider assembly I 36. The first-level X-axis motion unit 35 can be connected to the first-level Y-axis motion unit 34 via the X-axis linear guide rail slider assembly I 33. A slider of the X-axis linear guide rail slider assembly I 33 can be fixedly connected to the first-level X-axis motion unit 35 by bolts, and a linear guide rail of the X-axis linear guide rail slider assembly I 33 can be fixedly connected to the first-level Y-axis motion unit 34 by bolts, so that the first-level X-axis motion unit 35 and the first-level Y-axis motion unit 34 can slide relative to each other. Similarly, the first-level Y-axis motion unit 34 can be connected to the first-level Z-axis motion unit 31 via the Y-axis linear guide rail slider assembly I 36. A slider of the Y-axis linear guide rail slider assembly I 36 can be fixedly connected to the first-level Y-axis motion unit 34 by bolts, and a linear guide rail of the Y-axis linear guide rail slider assembly I 36 can be fixedly connected to the first-level Z-axis motion unit 31 by bolts, so that the first-level Y-axis motion unit 34 and first-level Z-axis motion unit 31 can slide relative to each other.

The second electromagnetic driving component 26 can include an electromagnetic actuation unit IV 261, an electromagnetic actuation unit V 262, and an electromagnetic actuation unit VI 263. The second-level platform 2 can include a second-level bottom plate 23, a second-level Y-axis motion unit 25, and a second-level X-axis motion unit 21. The guide protrusion 231 can be located on a bottom of the second-level bottom plate 23, and the electromagnetic actuation unit IV 261 can be configured for driving the second-level bottom plate 23 to move along the Z-axis direction and located between the guide protrusion 231 and the guide groove 342. That is, both the electromagnetic actuation unit III 373 and the electromagnetic actuation unit IV 261 are located between the guide protrusion 231 and the guide groove 342. In this way, the guide protrusion 231 can move within the guide groove 342 both along the X-axis direction and along the Z-axis direction. The guide protrusion 231 can be inserted within the guide groove 342 and be movable in the guide groove without in contact with sidewalls and bottom of the guide groove. When the second-level bottom plate 23 moves along the Z-axis direction until it contacts the first-level X-axis motion unit 35, the first-level X-axis motion unit 35 can assist in supporting the second-level bottom plate 23.

The second-level Y-axis motion unit 25 can be movably connected to the second-level bottom plate 23 along the Y-axis direction, and the electromagnetic actuation unit V 262 can be configured for driving the second-level Y-axis motion unit 25 to move along the Y-axis direction and located between the second-level Y-axis motion unit 25 and the second-level bottom plate 23. The second-level X-axis motion unit 21 can be movably connected to the second-level Y-axis motion unit 25 along the X-axis direction, the electromagnetic actuation unit VI 263 can be configured for driving the second-level X-axis motion unit 21 to move along the X-axis direction and located between the second-level X-axis motion unit 21 and the second-level Y-axis motion unit 25, and the motion platform 1 can be connected to the second-level X-axis motion unit 21. Specifically, the second-level bottom plate 23 can be provided with an U-shaped groove III 232, the second-level Y-axis motion unit 25 can be provided with a guide strip III 251 cooperating with the U-shaped groove III 232, and the electromagnetic actuation unit V 262 can be located between the U-shaped groove III 232 and the guide strip III 251. The second-level Y-axis motion unit 25 can be provided with an U-shaped groove IV 252, the second-level X-axis motion unit 21 can match with the U-shaped groove IV 252, and the electromagnetic actuation unit VI 263 can be located between the U-shaped groove IV 252 and the second-level X-axis motion unit 21.

In the present disclosure, the second-level platform 2 can further include a X-axis linear guide rail slider assembly II 24 and a Y-axis linear guide rail slider assembly II 22. The second-level Y-axis motion unit 25 can be connected to the second-level X-axis motion unit 21 via the X-axis linear guide rail slider assembly II 24. A slider of the X-axis linear guide rail slider assembly II 24 can be fixedly connected to the second-level X-axis motion unit 21 by bolts, and a linear guide rail of the X-axis linear guide rail slider assembly II 24 can be fixedly connected to the second-level Y-axis motion unit 25 by bolts, so that the second-level Y-axis motion unit 25 and the second-level X-axis motion unit 21 can slide relative to each other. The second-level Y-axis motion unit 25 can be connected to the second-level bottom plate 23 via the Y-axis linear guide rail slider assembly II 22. A slider of the Y-axis linear guide rail slider assembly II 22 can be fixedly connected to the second-level Y-axis motion unit 25 by bolts, and a linear guide rail of the Y-axis linear guide rail slider assembly II 22 can be fixedly connected to the second-level bottom plate 23 by bolts, so that the second-level Y-axis motion unit 25 and second-level bottom plate 23 can slide relative to each other.

In one or more embodiments, a grating ruler sensor I 61 configured for detecting a relative position between the first-level bottom plate 32 and the first-level Z-axis motion unit 31 can be provided between the U-shaped groove I 321 and the guide strip I 311. A grating sensor II 62 configured for detecting a relative position between the first-level Z-axis motion unit 31 and the first-level Y-axis motion unit 34 can be provided between the U-shaped groove II 312 and the guide strip II 341. A grating sensor III 63 configured for detecting a relative position between the first-level Y-axis motion unit 34 and the second-level bottom plate 23 along the X-axis direction and a grating ruler sensor IV 64 configure for detecting a relative position of the first-level Y-axis motion unit 34 and the second-level bottom plate 23 along the Z-axis direction can be provided in the guide protrusion 231 and the guide groove 342. A grating ruler sensor V 65 configured for detecting a positional relationship between the second-level bottom plate 23 and the second-level Y-axis motion units 25 can be provided between the U-shaped Groove III 232 and the guide strip III 251. A grating ruler sensor VI 66 configured for detecting a positional relationship between the second-level Y-axis motion unit 25 and the second-level X-axis motion unit 21 can be provided between the U-shaped groove IV 252 and the second-level X-axis motion unit 21. The grating ruler sensor I 61, the grating ruler sensor II 62, the grating ruler sensor III 63, the grating ruler sensor IV 64, the grating ruler sensor V 65 and the grating ruler sensor VI 66 can be connected to controller 4. The positional relationship between two components with mutual movement can be detected by the grating ruler sensor, and the controller 4 can adjust corresponding electromagnetic actuation units according to the positional relationship, respectively.

In one or more embodiments, the spatial location precision stabilization system 100 with dual level multi-degree of freedom can further include a detection unit 5.

The detection unit 5 can be configured to detect a position variation of the motion platform 1. When the position variation of the motion platform 1 detected by the detection unit 5 reaches a preset value, the controller 4 is capable of controlling the first electromagnetic driving component 37 to adjust the motion platform 1. When the position variation of the motion platform 1 detected by the detection unit 5 does not reach the preset value, the controller 4 is capable of controlling the second electromagnetic driving component 26 to adjust the motion platform 1.

It can be understood that when the position variation of the motion platform 1 is great, the controller 4 can control the first electromagnetic driving component 37, so as to coarsely adjust the motion platform 1 in the spatial location along three-degree-of-freedom via electromagnetic actuation of the first-level platform 3. When the position variation of the motion platform 1 is small, the controller 4 can control the second electromagnetic driving component 26, so as to finely adjust the motion platform 1 in the spatial location along three-degree-of-freedom via electromagnetic actuation of the second-level platform 2.

In one or more embodiments, the spatial location precision stabilization system 100 with dual level multi-degree of freedom can further include a detection unit 5.

The detection unit 5 can be configured to detect a position variation of the motion platform 1 in three directions of X-axis, Y-axis and Z-axis. For a position variation in the X-axis direction, when the detection unit 5 detects that the position variation in the X-axis direction reaches a preset value, the controller 4 is capable of controlling the electromagnetic actuation unit III 373 of the first electromagnetic driving component 37 to adjust the motion platform 1, and when the detection unit 5 detects that the position variation in the X-axis direction does not reach the preset value, the controller 4 is capable of controlling the electromagnetic actuation unit VI 263 of the second electromagnetic driving component 26 to adjust the motion platform 1. For a position variation in the Y-axis direction, when the detection unit 5 detects that the position variation in the Y-axis direction reaches a preset value, the controller 4 is capable of controlling the electromagnetic actuation unit II 372 of the first electromagnetic driving component 37 to adjust the motion platform 1, and when the detection unit 5 detects that the position variation in the Y-axis direction does not reach the preset value, the controller 4 is capable of controlling the electromagnetic actuation unit V 262 of the second electromagnetic driving component 26 to adjust the motion platform 1. For a position variation in the Z-axis direction, when the detection unit 5 detects that the position variation in the Z-axis direction reaches a preset value, the controller 4 is capable of the electromagnetic actuation unit I 371 of the first electromagnetic driving component 37 to adjust the motion platform 1, and when the detection unit 5 detects that the position variation in the Z-axis direction does not reach the preset value, the controller 4 is capable of the electromagnetic actuation unit IV 261 of the second electromagnetic driving component 26 to adjust the motion platform 1.

Different from the control logic of the detection unit 5 mentioned above, in the present embodiment, coarse adjustment and fine adjustment can be performed simultaneously in each of axial directions of X-axis, Y-axis and Z-axis, thereby realizing stepless adjustment of the spatial location in two displacement magnitudes. For example, the fine adjustment along the X-axis direction can be performed by the second-level platform 2, while the coarse adjustment along the Y-axis direction and the Z-axis direction can be performed by the first-level platform 3.

In one or more embodiments, the preset value can be in a range from 0.1 mm to 2 mm, and in the present disclosure, the preset value can be 1 mm.

The basic principles, main features, and advantages of the present disclosure are shown and described above. It should be understood by those skilled in the art that the embodiments mentioned above are not intended to limit the present disclosure in any form, and all the technical solutions obtained by means of equivalent replacement or equivalent transformation fall within the scope of the present disclosure.

We claim:

1. A spatial location precision stabilization system with dual level multi-degree of freedom, comprising
a motion platform;
a second-level platform connected to the motion platform and located below the motion platform, wherein the second-level platform is provided with a second electromagnetic driving component to adjust a position of the motion platform in multiple directions by means of electromagnetic actuation;
a first-level platform connected to the second-level platform and located below the second-level platform, wherein the first-level platform is provided with a first electromagnetic driving component to adjust the second-level platform in multiple directions by means of electromagnetic actuation, so as to adjust the position of the motion platform; and
a controller connected to the first electromagnetic driving component and the second electromagnetic driving component and configured to control the first electromagnetic driving component and the second electromagnetic driving component.

2. The spatial location precision stabilization system of claim 1, wherein
the second-level platform is configured to adjust the position of the motion platform along three directions of X-axis, Y-axis and Z-axis under driven by the second electromagnetic driving component; and
the first-level platform is configured to adjust the second-level platform along three directions of X-axis, Y-axis and Z-axis under driven by the first electromagnetic driving component, so as to adjust the position of the motion platform.

3. The spatial location precision stabilization system of claim 2, wherein
the first electromagnetic driving component comprises an electromagnetic actuating unit I, an electromagnetic actuating unit II, and an electromagnetic actuating unit III;
the first-level platform comprises:
a first-level bottom plate;
a first-level Z-axis motion unit movably connected to the first-level bottom plate along a Z-axis direction, wherein an electromagnetic actuation unit I is disposed between the first-level Z-axis motion unit and the first-level bottom plate and configured for driving the first-level Z-axis motion unit to move along the Z-axis direction;
a first-level Y-axis motion unit movably connected to the first-level Z-axis motion unit along a Y-axis direction, wherein an electromagnetic actuation unit II is disposed between the first-level Y-axis motion unit and the first-level Z-axis motion unit and configured for driving the first-level Y-axis motion unit to move along the Y-axis direction; and
a first-level X-axis motion unit movably connected to the first-level Y-axis motion unit along a X-axis direction, wherein the first-level Y-axis motion unit is provided with a guide groove, a bottom of the second-level platform is provided with a guide protrusion matching with the guide groove, and an electromagnetic actuation unit III is disposed between the guide protrusion and the guide groove and configured for driving the second-level platform to move along the X-axis direction.

4. The spatial location precision stabilization system of claim 3, wherein,
the first-level bottom plate is provided with an U-shaped groove I, the first-level Z-axis motion unit is provided with a guide strip I cooperating with the U-shaped groove I, and the electromagnetic actuation unit I is located between the U-shaped groove I and the guide strip I;
the first-level Z-Axis motion unit is provided with an U-shaped groove II, the first-level Y-axis motion unit is provided with a guide strip II cooperating with the U-shaped groove II, and the electromagnetic actuation unit II is located between the U-shaped groove II and the guide strip II.

5. The spatial location precision stabilization system of claim 4, wherein
the second electromagnetic driving component comprises an electromagnetic actuation unit IV, an electromagnetic actuation unit V, and an electromagnetic actuation unit VI,
the second-level platform comprises:
a second-level bottom plate, wherein the guide protrusion is located on a bottom of the second-level bottom plate, and the electromagnetic actuation unit IV is configured for driving the second-level bottom plate to move along the Z-axis direction and located between the guide protrusion and the guide groove;
a second-level Y-axis motion unit movably connected to the second-level bottom plate along the Y-axis direction, wherein the electromagnetic actuation unit V is configured for driving the second-level Y-axis motion unit to move along the Y-axis direction and located between the second-level Y-axis motion unit and the second-level bottom plate; and
a second-level X-axis motion unit movably connected to the second-level Y-axis motion unit along the X-axis direction, wherein an electromagnetic actuation unit VI is configured for driving the second-level X-axis motion unit to move along the X-axis direction and located between the second-level X-axis motion unit and the second-level Y-axis motion unit, and the motion platform is connected to the second-level X-axis motion unit.

6. The spatial location precision stabilization system of claim 5, wherein
the second-level bottom plate is provided with an U-shaped groove III, the second-level Y-axis motion unit is provided with a guide strip III cooperating with the U-shaped groove III, and the electromagnetic actuation unit V is located between the U-shaped groove III and the guide strip III; and
the second-level Y-axis motion unit is provided with an U-shaped groove IV, the second-level X-axis motion unit matches with the U-shaped groove IV, and the electromagnetic actuation unit VI is located between the U-shaped groove IV and the second-level X-axis motion unit.

7. The spatial location precision stabilization system of claim 6, wherein
a grating ruler sensor I configured for detecting a relative position between the first-level bottom plate and the first-level Z-axis motion unit is provided between the U-shaped groove I and the guide strip I;
a grating sensor II configured for detecting a relative position between the first-level Z-axis motion unit and the first-level Y-axis motion unit is provided between the U-shaped groove II and the guide strip II;
a grating sensor III configured for detecting a relative position between the first-level Y-axis motion unit and the second-level bottom plate along the X-axis direction and a grating ruler sensor IV configure for detecting a relative position of the first-level Y-axis motion unit and the second-level bottom plate along the Z-axis direction are provided in the guide protrusion and the guide groove;
a grating ruler sensor V configured for detecting a positional relationship between the second-level bottom plate and the second-level Y-axis motion units is provided between the U-shaped Groove III and the guide strip III; and
a grating ruler sensor VI configured for detecting a positional relationship between the second-level Y-axis motion unit and the second-level X-axis motion unit is provided between the U-shaped groove IV and the second-level X-axis motion unit.

8. The spatial location precision stabilization system of claim 7, further comprising
a detection unit configured to detect a position variation of the motion platform,
wherein when the position variation of the motion platform detected by the detection unit reaches a preset value, the controller is capable of controlling the first electromagnetic driving component to adjust the motion platform;
when the position variation of the motion platform detected by the detection unit does not reach the preset value, the controller is capable of controlling the second electromagnetic driving component to adjust the motion platform.

9. The spatial location precision stabilization system of claim 7, further comprising
a detection unit configured to detect a position variation of the motion platform in three directions of X-axis, Y-axis and Z-axis,
for a position variation in the X-axis direction, when the detection unit detects that the position variation in the X-axis direction reaches a preset value, the controller is capable of controlling the electromagnetic actuation unit III of the first electromagnetic driving component to adjust the motion platform, and when the detection unit detects that the position variation in the X-axis direction does not reach the preset value, the controller is capable of controlling the electromagnetic actuation unit VI of the second electromagnetic driving component to adjust the motion platform;
for a position variation in the Y-axis direction, when the detection unit detects that the position variation in the Y-axis direction reaches a preset value, the controller is capable of controlling the electromagnetic actuation unit II of the first electromagnetic driving component to adjust the motion platform, and when the detection unit detects that the position variation in the Y-axis direction does not reach the preset value, the controller is capable of controlling the electromagnetic actuation unit V of the second electromagnetic driving component to adjust the motion platform; and
for a position variation in the Z-axis direction, when the detection unit detects that the position variation in the Z-axis direction reaches a preset value, the controller is capable of the electromagnetic actuation unit I of the first electromagnetic driving component to adjust the motion platform, and when the detection unit detects that the position variation in the Z-axis direction does not reach the preset value, the controller is capable of the electromagnetic actuation unit IV of the second electromagnetic driving component to adjust the motion platform.

10. The spatial location precision stabilization system of claim 8, wherein
the preset value is in a range from 0.1 mm to 2 mm.

11. The spatial location precision stabilization system of claim 9, wherein
the preset value is in a range from 0.1 mm to 2 mm.
